(19) United States
(12) Patent Application Publication
(10) Pub. No.: US 2002/0099716 A1
(43) Pub. Date: Jul. 25, 2002

(54) Technique and apparatus to process data

(76) Inventor: Chad Grey Thompson, Kuna, ID (US)

Correspondence Address: Fred G. Pruner, Jr., TROP, PRUNER & HU, P.C., Suite 100, 8554 Katy Freeway, Houston, TX, 77024, US

(21) Appl. No.: 09/769,872

(22) Filed: Jan. 25, 2001

(51) Int. Cl. G06F 7/00

(52) U.S. Cl. 707/102

(57) ABSTRACT

A technique to perform a task on data includes dividing the data into a plurality of blocks; and using a database manager to create a plurality of subtasks. Each subtask executes in parallel with the other subtask(s) to process a different one of the blocks of data to perform the task

### BACKGROUND

The invention generally relates to a technique and apparatus to process data.

To facilitate the storage and retrieval of large amounts of data, the data may be organized and stored in a database. In this manner, communication with the database typically is controlled by a database manager that is established, in turn, by the execution of a database management program (a program made by Oracle®, for example). The database manager may be customized to perform various tasks. For example, one set of tasks may be associated with the processing of payroll. In this manner, child processes may set up by a system administrator or a database administer to sequentially handle different parts of the payroll calculations. These child processes are executed via the platform that is provided by the database manager. Each child process is dedicated to a different part of the payroll calculation, processes a block of data having a predefined size and requires specialized skills in setting up the process.

As noted, the child processes typically are designed to be executed in a sequential manner on a single central processing unit (CPU). However, a typical server (which establishes the database manager) typically has several CPUs that are available for processing. Thus, such an arrangement does not utilize the full capability of the server.

Thus, there is a continuing need for an arrangement and/or technique to address one or more of the problems that are stated above.

### SUMMARY

In an embodiment of the invention, a technique to perform a task on data includes dividing the data into a plurality of blocks; and using a database manager to create a plurality of subtasks. Each subtask executes in parallel with the other subtask(s) to process a different one of the blocks of data to perform the task.

Advantages and other features of the invention will become apparent from the following drawing, description and claims.

### BRIEF DESCRIPTION OF THE DRAWING

FIG. 1 is a schematic diagram of a system according to an embodiment of the invention.

FIG. 2 is a flow diagram depicting a technique in accordance with an embodiment of the invention.

FIG. 3 is a schematic diagram of a software architecture of a server of FIG. 1 according to an embodiment of the invention.

FIG. 4 is a flow diagram depicting a technique in accordance with an embodiment of the invention.

FIG. 5 is a schematic diagram of a computer system according to an embodiment of the invention.

### DETAILED DESCRIPTION

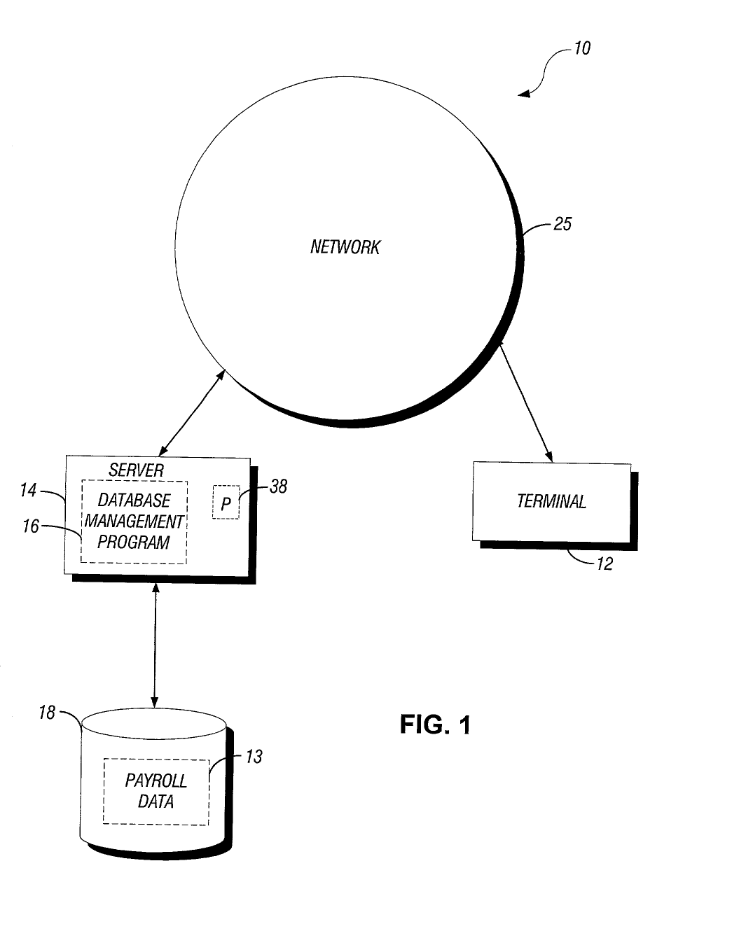

Referring to FIG. 1, an embodiment 10 of a system in accordance with the invention includes a server 14 that is coupled to a terminal 12 via a network 25. As an example, the server 14 controls access to a database 18 for purposes of storing data in and retrieving data form the database 18. The database 18 may include a variety of stored information (such as payroll data 13, for example) and may be a relational database, in some embodiments of the invention.

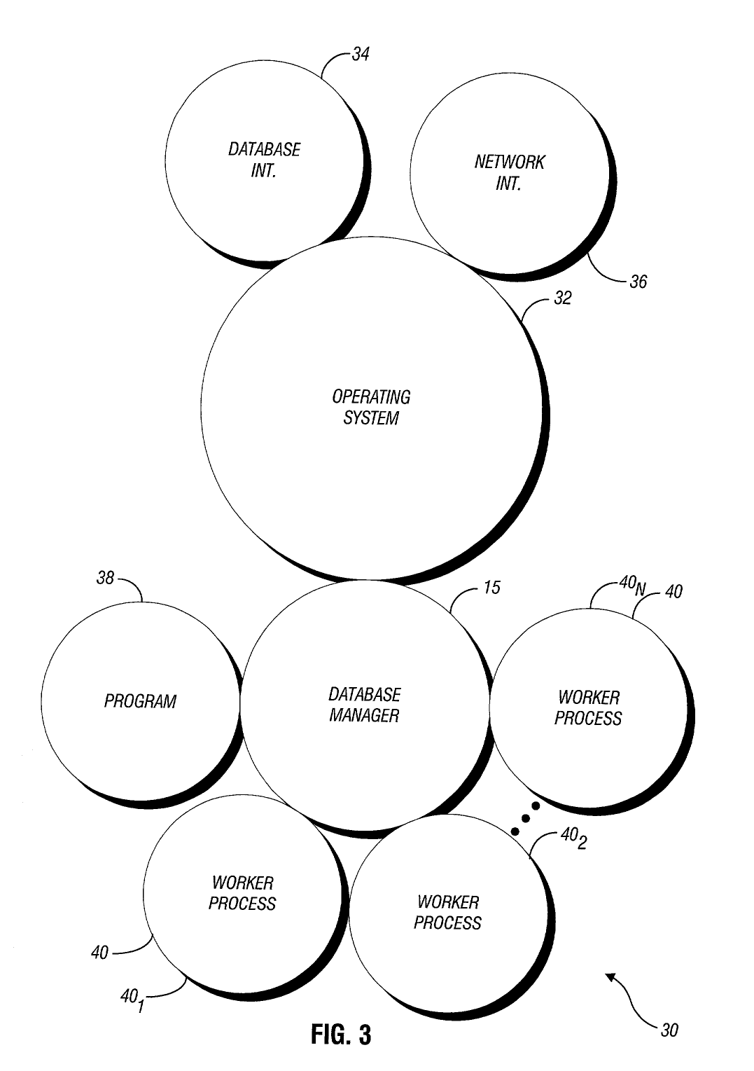

Referring also to FIG. 3, in some embodiments of the invention, the server 14 may execute a database management program 16 (a database management program made by Oracle®, for example) to establish a database manager 15 for purposes of communicating data to and from the database 18. In some embodiments of the invention, if a particular task is capable of being broken down into subtasks that can be executed in parallel, then the database manager 15 divides the tasks into concurrent processes, called worker processes 40 (processes 40₁, 40₂ . . . 40_{N}, shown as examples). Each worker process 40 provides the resources (program instructions, etc.) to execute its associated subtask. In this context of this application, “executed in parallel” or “performed in parallel” refers to the execution or performance of one or more subtasks at approximately the same time. Thus, during a particular time interval, all of the subtasks are being executed or performed.

The execution of a particular subtask involves the execution of program instructions. In this manner, in some embodiments of the invention, the same program instructions are executed for each subtask. These program instructions, in turn, may be sequential in nature in that a sequential hierarchy exists in which one program instruction is executed before the next.

The division of the task into subtasks involves the division of the data to be processed by the task. Thus, in some embodiments of the invention, the data to be processed by the task may be divided into blocks of data, and each subtask processes one of these blocks of data. Therefore, instead of using the main task to process the entire block of data, in some embodiments of the invention, the functions of the main task are replicated by each subtask. However, each subtask processes a fraction of the total data that would be processed by the main task. Therefore, the parallel processing of the subtasks takes advantage of multiple central processing units (CPUs) and hardware configurations that may form the server 14. In this manner, a process that is run on a server with eight CPUs may create between four to sixteen concurrent processes and finish the process four to sixteen times as fast as a single concurrent process minus the software overhead.

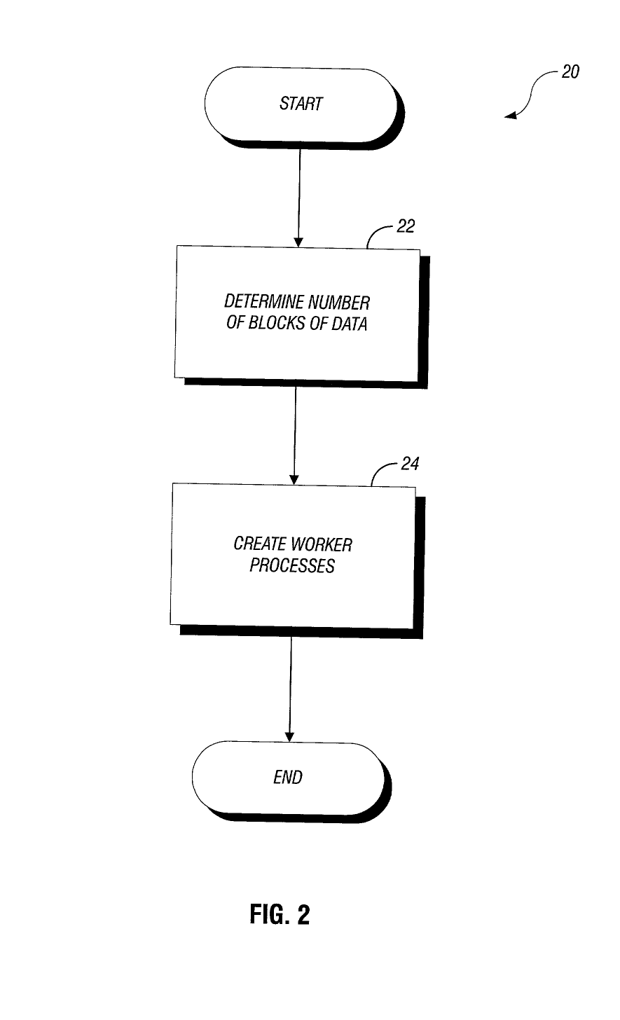

Thus, referring to FIG. 2, a technique 20 in accordance with the invention includes determining (block 22) the number of blocks of data to process a particular task and creating (block 24) worker processes that each perform a similar subtask to process the blocks in parallel to complete the task.

Referring back to FIG. 3, in this manner, the database manager 15 may execute a program 38 (a script, for example) to divide a particular task into the subtasks (each of which processes an associated block of data) and spawn the appropriate number of worker processes 40 to accomplish the task.

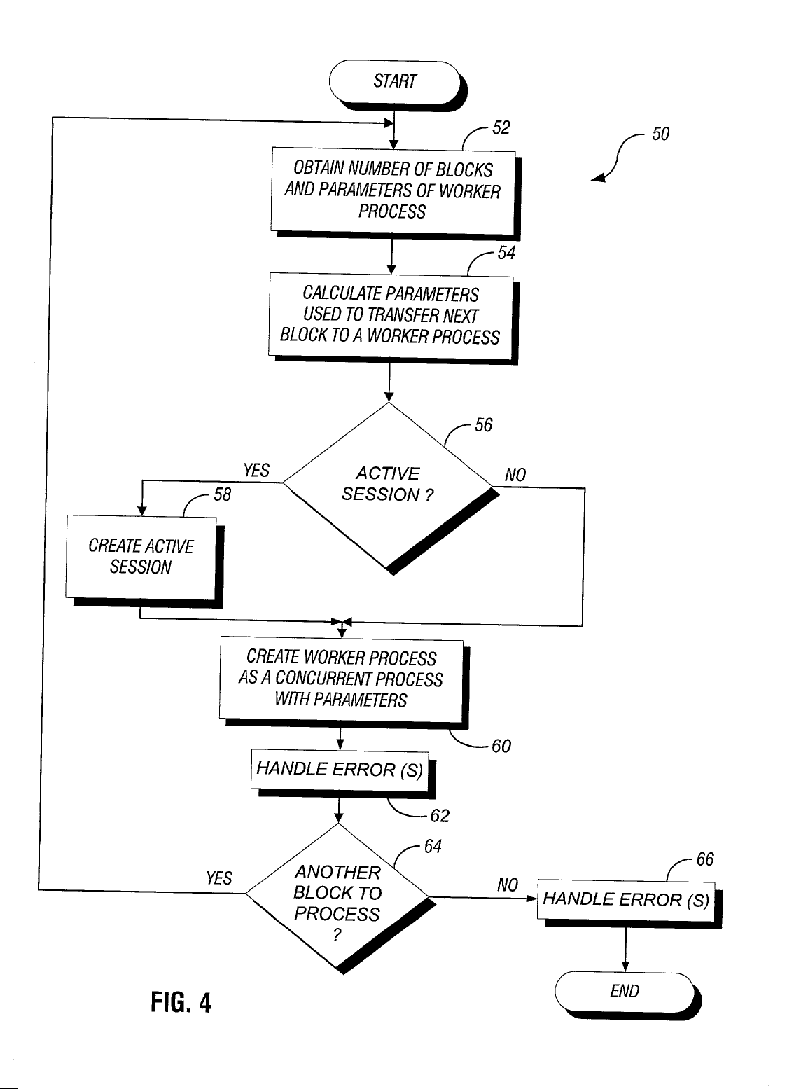

As a more specific example, FIG. 4 depicts a technique 50 that may be performed by the server's execution of the program 38. In the technique 50, the program 38, when executed by the server 14, obtains (block 52) a number of blocks of data (each of which is processed via a different worker process) and obtains parameters to be used with each worker process. Next, the technique 50 includes calculating (block 54) the parameters that are used to transfer the next block of data to a worker process. If the server 14 determines (diamond 56) that an active session does not currently exist, then the server 14 creates (block 58) an active session. Next, the server 14 creates a worker process, a concurrent process, with the specified parameters, as indicated in block 60. To complete the processing of the current worker process, the server 14 handles (block 62) any error(s) and determines whether there is another block of data to process, as indicated in diamond 64. If so, then control returns to block 52. Otherwise, the server 14 handles any additional error(s) (block 66) and terminates the technique 50.

As a more specific example, each worker process 40 may provide the resources to execute the same PLSQL script to perform a particular payroll calculation (i.e., to perform a particular subtask), for example. These payroll calculations, in turn, may be executed in parallel on different blocks of data to perform a specific payroll calculation task. In this manner, the program 38 may cause the server 14 to query a person table in the database 18 to create a list of employee numbers. These employee numbers may then be used, for example, to break the overall payroll tasks up into subtasks, each of which is associated with a different group of employees and thus, is associated with a different block of data. For example, 1,000 employees may need to be broken up into four blocks, so that each block of data is associated with the information relating to a different 250 employees.

Next, the program 38 causes the server 14 to perform a series of loops, with each loop being associated with a different block of employees. Thus, the first loop may calculate payroll information for employee numbers 0 to 1,500, the second process may process employee numbers from 1,501 to 3,000, etc.

The advantages of the above-described technique may include one or more of the following. A parallelizable process may be split up and run on as many concurrent database managers that are made available. Given that databases typically are run on servers with multiple CPUs and a high number of available standard concurrent managers, this method may speed up processing without incurring additional hardware costs or difficult software maintenance and monitoring. The number of parallel running concurrent managers may be set when the process is run. This allows end users to adjust the number of data blocks in the parallelization of the process to match business and system requirements, or even a hardware change such as running on a new server with double the number of CPUs without requiring code or administrative changes by technical resources, database administrator or system administrator, as examples. Other advantages are possible.

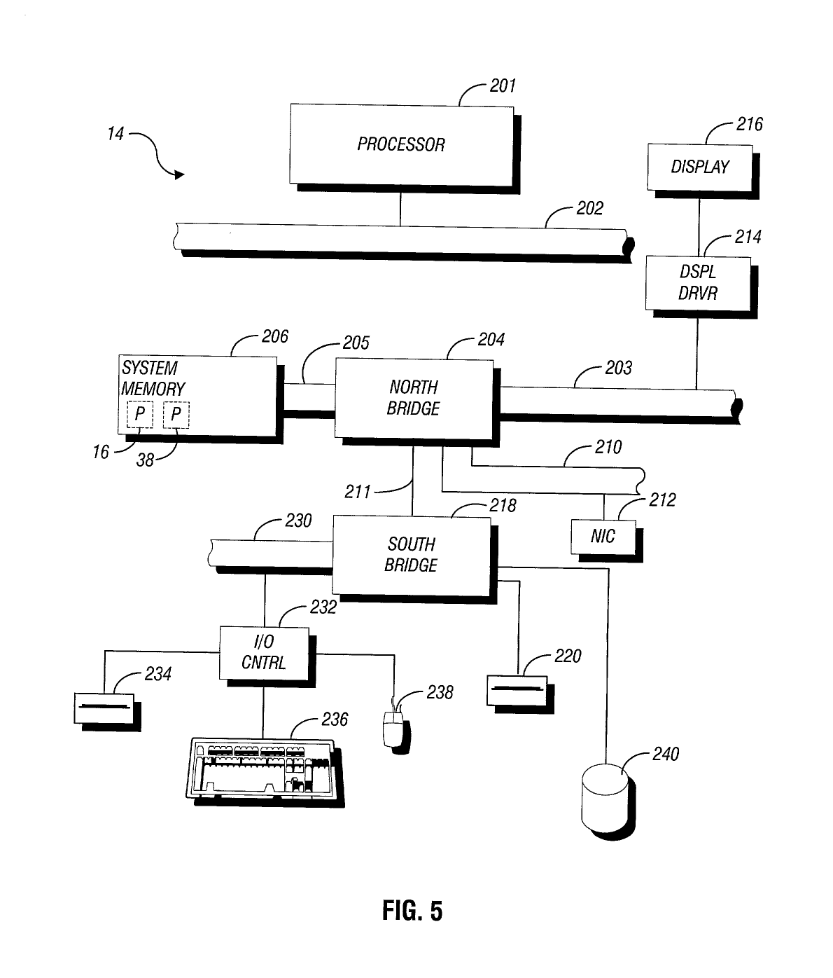

Referring to FIG. 5, in some embodiments of the invention, the server 14 may include a processor 201 to execute the program 38 that is stored in a memory 206 of the server 14 along with instructions of the database management program 16 to establish the database manager 15. The processor 201 may be coupled to a local bus 202 along with a north bridge 204. The north bridge 204 may represent a collection of semiconductor devices, or “chip set,” and provide interfaces to a Peripheral Component Interconnect (PCI) bus 210 and an AGP bus 203. The PCI Specification is available from The PCI Special Interest Group, Portland, Oreg. 97214. The AGP is described in detail in the Accelerated Graphics Port Interface Specification, Revision 1.0, published on Jul. 31, 1996, by Intel Corporation of Santa Clara, Calif.

A display driver 214 may be coupled to the AGP bus 203 and provide signals to drive a display 216. The PCI bus 210 may be coupled to a network interface card (NIC) 212 that provides a communication interface for the computer system 10 to the network 25 (see FIG. 1). The north bridge 204 may also include a memory controller to communicate data over a memory bus 205 with a memory 206. As an example, the memory 206 may store all or a portion of program instructions associated with the database management program 16 (see FIG. 1), the program 38 and the operating system 12. In some embodiments of the invention, some of the above-described software may be executed on another computer system that is coupled to the computer system 10 via a network, such as the network 25.

The north bridge 204 communicates with a south bridge 218 via a hub link 211. The south bridge 218 may represent a collection of semiconductor devices, or “chip set,” and provide interfaces for a hard disk drive 240, a CD-ROM drive 220 and an I/O expansion bus 230, as just a few examples. The hard disk drive 240 may store all or a portion of the instructions of the database management program 16, the program 38 and the operating system 12, in some embodiments of the invention.

An I/O controller 232 may be coupled to the I/O expansion bus 230 to receive input data from a mouse 238 and a keyboard 236. The I/O controller 232 may also control operations of a floppy disk drive 234.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method to perform a task on data, comprising:
dividing the data in a plurality of blocks of data;
using a database manager to create a plurality of subtasks; and
executing the subtasks in parallel with the remaining of said plurality of subtasks to process a different one of the blocks of data to perform the task.

2. The method of claim 1, wherein the act of executing the subtasks comprises:
executing substantially the same instructions for each subtask.

3. The method of claim 1, wherein the act of executing the subtasks comprises:
executing instructions for each subtask in a sequential order.

4. The method of claim 3, wherein the instructions comprises structured query language instructions.

5. The method of claim 1, further comprising:
retrieving the blocks of data from a database.

6. The method of claim 1, wherein the act of using the database manager to create the subtasks comprises:
creating concurrent processes, each concurrent process being associated with a different one of the subtasks.

7. The method of claim 1, wherein the task comprises calculating payroll information.

8. An article comprising a computer readable storage medium storing instructions to cause a computer to:
divide data in a plurality of blocks of data,
use a database manager to create a plurality of subtasks, and
execute the subtasks in parallel with the remaining of said plurality of subtasks to process a different one of the blocks of data to perform a task.

9. The article of claim 8, the storage medium storing instructions to cause the computer to execute substantially the same instructions for each subtask.

10. The article of claim 8, the storage medium storing instructions to cause the computer to execute instructions for each subtask in a sequential order.

11. The article of claim 8, wherein the instructions comprises structured query language instructions.

12. The article of claim 8, the storage medium storing instructions to cause the computer to retrieve the blocks of data from a database.

13. The article of claim 8, the storage medium storing instructions to cause the computer to create concurrent processes, each concurrent process being associated with a different one of the subtasks.

14. The article of claim 8, the storage medium storing instructions to cause the task comprises calculating payroll information.

15. A computer system comprising:
a database storing data; and
a processor coupled to the database and adapted to:
divide data in a plurality of blocks of data,
use a database manager to create a plurality of subtasks, and
execute the subtasks in parallel with the remaining of said plurality of subtasks to process a different one of the blocks of data to perform a task.

16. The computer system of claim 15, wherein the processor is further adapted to execute substantially the same instructions for each subtask.

17. The computer system of claim 15, wherein the processor is further adapted to execute instructions for each subtask in a sequential order.

18. The computer system of claim 15, wherein the instructions comprise structured query language instructions.

19. The computer system of claim 15, wherein the processor is further adapted to cause the computer to retrieve the blocks of data from a database.

20. The computer system of claim 15, wherein the processor is further adapted to cause the computer to create concurrent processes, each concurrent process being associated with a different one of the subtasks.

21. The computer of claim 15, wherein the processor is further adapted to cause the task comprises calculating payroll information.
